(19) United States
(12) Patent Application Publication
(10) Pub. No.: US 2026/0088547 A1
(43) Pub. Date: Mar. 26, 2026

(54) CHARGING COUPLING FOR ROBOTIC MOWER

(71) Applicant: Greenworks (Jiangsu) Co., Ltd, Changzhou (CN)

(72) Inventors: Stefan Strandberg, Jonkoping (SE); Oscar Abrahamsson, Jonkoping (SE); Jimmy Alzen, Granna (SE)

(21) Appl. No.: 19/403,060

(22) Filed: Nov. 27, 2025

Related U.S. Application Data
(63) Continuation of application No. PCT/CN2023/099079, filed on Jun. 8, 2023.

(51) Int. Cl. H01R 13/187; H01R 13/26; A01D 34/00; A01D 101/00

(52) U.S. Cl. CPC H01R 13/187; H01R 13/26; A01D 34/00; A01D 2101/00

(57) ABSTRACT

A charging coupling for connecting a robotic mower to a charging station, comprising a first charging contact provided on the robotic mower and a second charging contact provided on the charging station. The first charging contact comprising a recess with two side walls substantially perpendicular to a mowing surface of the robotic mower, each side wall is provided with an essentially rectangular resilient metal plate. The second charging contact comprising a protruding part configured to fit in the recess of the first charging contact and has two sides facing the two side walls of the recess of the first charging contact when in contact. Each side of the protruding part is provided with metal plates with its sharp side facing the surface of the resilient metal plates of the first charging contact, when in contact.

### CROSS REFERENCE TO RELATED APPLICATIONS

The present application is a Continuation Application of PCT Application No. PCT/CN2023/099079 filed on June 8, 2023, the contents of which are incorporated herein by reference in their entirety.

### TECHNICAL FIELD

The present invention relates generally to robotic mowers and more particular to a charging coupling for connecting a robotic mower to a charging station.

### BACKGROUND ART

Robotic mowers have become more and more popular and are widely used for cutting grass. The robotic mower is typically autonomous and is powered by a battery provided on the robotic mower. Since, the robotic mower is powered by a battery it needs to be recharged periodically. When the robotic mower detects that the power in the battery falls below a predetermined level it will return to a charging station and charge the battery.

When returning to the charging station the robotic mower will dock with the charging station and the charging process will start. To enable charging the robotic mower is provided with a charging contact configured to match with a corresponding charging contact on the charging station, such that electric current may be transferred between the charging station and the robotic mower.

The charging contacts of the robotic mower and the charging station are typically provided with resilient metal plates to ensure electrical contact. One problem with these metal plates, and especially of the charging contact of the charging station, is that they with time become cluttered with oxide, which makes the charging process less efficient. Furthermore, poor contact between the metal plates may also lead to heat generation in the charging connection with further loss of energy and potentially also may be hazardous. The reason why the oxide problem for the charging contact is greater for the charging station is that the charging station is more exposed to weather conditions as it is not protected by a cover as the robotic mower.

EP 2571344 discloses charging contacts provided on a robotic mower and a charging station with multiple contact points there in between in order to increase the charging efficiency.

Thus, there is a need to improve the charging contacts between the robotic mower and the charging station in order to increase the efficiency of the charging process and specially to remove oxide on the charging contacts.

### SUMMARY OF INVENTION

An object of the present invention is to increase the efficiency of the charging process between the robotic mower and the charging station and in particular by avoiding the charging contacts from being cluttered with oxide.

The above problem is solved by a charging coupling for connecting a robotic mower to a charging station, wherein a first charging contact of the charging coupling is provided on the robotic mower and a second charging contact is provided on the charging station. The first charging contact comprising a recess having two side walls substantially perpendicular to a mowing surface of the robotic mower and wherein each side wall is provided with a resilient metal plate. The second charging contact comprises a protruding part configured to fit in the recess of the first charging contact and has two sides facing the two side walls of the recess of the first charging contact when in contact. Each side wall of the protruding part is provided with metal plates with its sharp side facing the surface of the resilient metal plates of the first charging contact when in contact.

The protruding part 16 of the second charging contact has a front part, which is U-shaped and wherein the legs of the U constitute the sides of the second charging contact 8.

In another exemplary embodiment the charging coupling, each resilient metal plate is fixed to an end wall of the recess and to a front of the recess and is essentially arc-shaped there in between along the side wall and with the arc protruding into the recess.

In yet another exemplary embodiment the charging coupling, each resilient metal plate is fixed along and extending parallel to the end wall and has an angle of 100°-135° between the part fixed to the end wall and the arc-shaped part of the resilient metal plate extending into the recess.

In an exemplary embodiment the charging coupling, the metal plates of the second charging contact are inserted into the side walls of the protruding part.

In another exemplary embodiment the charging coupling, the second charging contact is made of two parts, one upper part and one lower part in relation to the mowing surface, wherein either the upper part or the lower part is provided with a ridge adapted to mate with an opening provided in the metal plates of the second charging contact.

In another embodiment the charging coupling, the height of the resilient metal plate is between 3-15 mm, preferably between 4-12 mm and more preferably between 5-10 mm.

In yet another exemplary embodiment the charging coupling, the thickness of the metal plates of the second charging contact is between 0.5-4 mm, preferably between 0.5-3 mm and more preferably between 0.7-1.5 mm.

In another exemplary embodiment the resilient metal plate is essentially rectangular with its height extending essentially in parallel with the side wall and its width extending along the side wall.

With the present invention the problem with oxide cluttered on the charging contacts is solved by providing the metal plates of the second charging contact such that the sharp sides of the metal plates make contact with the resilient metal plates of the first charging contact and when making contact grinds off the oxide from the charging contacts.

Furthermore, by forming the front of the protruding part with a U-shape, i.e. with an air gap between the both the legs of the U, conduction of current between the two metal plates of the second charging contact is prevented, which further prevents degradation and/or oxidation of the metal plates.

### BRIEF DESCRIPTION OF DRAWINGS

The invention is now described, by way of example, with reference to the accompanying drawings, in which:

FIG. 1 is a perspective view of a charging station and a robotic mower.

FIG. 2 is a perspective view of the charging coupling comprising a first charging contact and a second charging contact.

FIG. 3 is a view from above of the charging coupling comprising the first charging contact and the second charging contact.

FIG. 4 is a schematic view from above the first charging contact.

FIG. 5 is schematic view of the metal plates of the first and second charging contact.

FIG. 6 is a schematic view of an upper part and a lower part of the second charging contact.

### DESCRIPTION OF EMBODIMENTS

In the following, a detailed description of a charging coupling 100 for connecting a robotic mower 2 to a charging station 4 according to the present invention will be made.

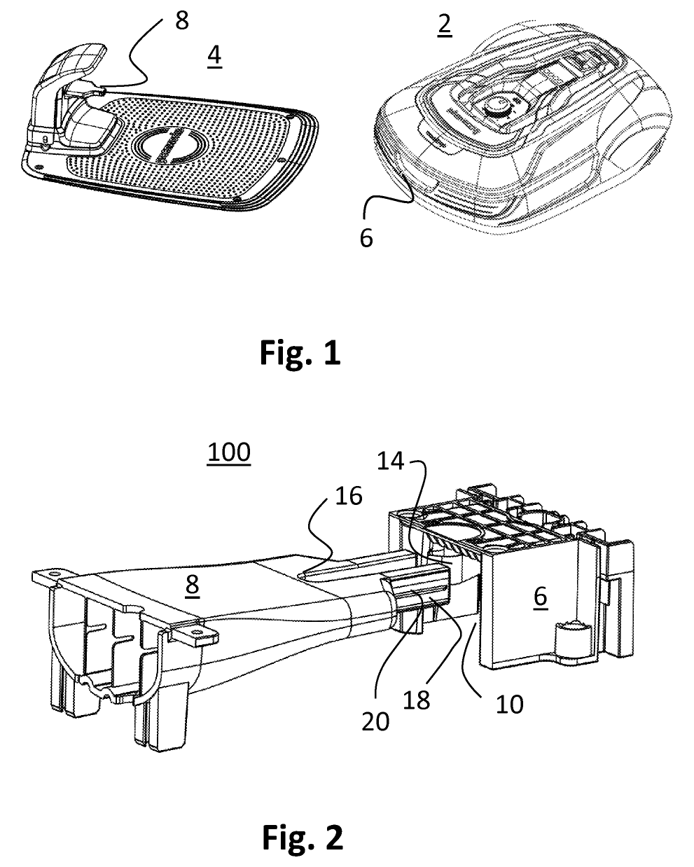

FIG. 1 is a perspective view of a robotic mower 2 and a charging station 4. The robotic mower 2 is provided with a first charging contact 6 and the charging station 4 is provided with a second charging contact 8, which together constitute the charging coupling 100. The first charging contact 6 is provided in the robotic mower 2 such that is protected by the cover of the robotic mower 2 and is formed in a recess. The second charging contact 8 is configured such as it mates with the recess of the first charging contact 6 when the charging coupling 100 is complete and charging of the robotic mower 2 is performed.

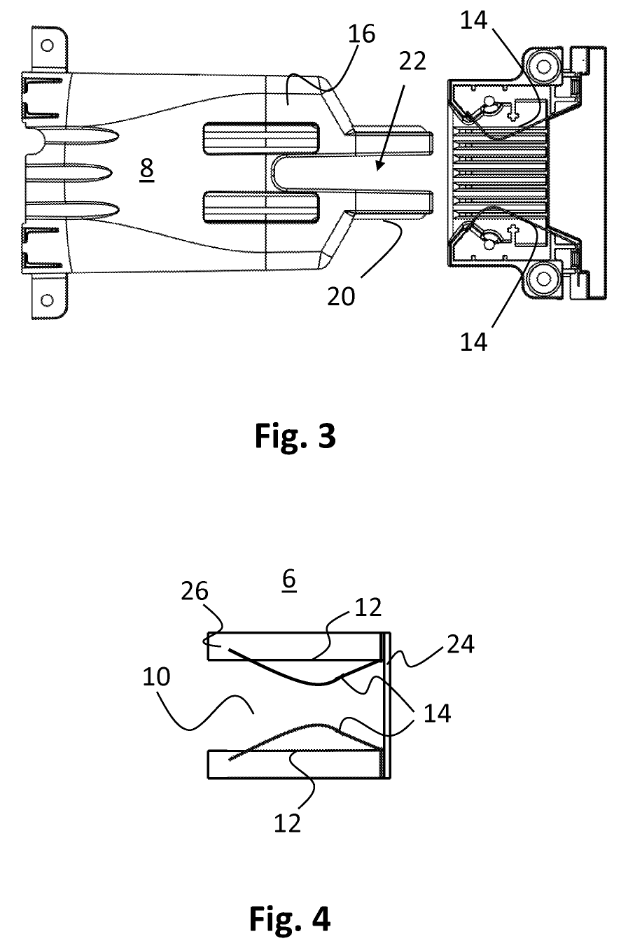

Turning now to FIG. 2, FIG. 3 and FIG. 4 the charging coupling 100 will be described in greater detail. As mentioned above the charging coupling 100 comprises the first charging contact 6 provided on the robotic mower 2 and a second charging contact 8 provided on the charging station 4. The first charging contact 6 comprises a recess 10. The recess 10 has two side walls 12 that are substantially perpendicular to a mowing surface of the robotic mower 2. Each side wall 12 is provided with an essentially rectangular resilient metal plate 14. The height of the rectangular resilient plate 14 extends essentially in parallel with the side wall 12 and its width extends along the side wall 12. The second charging contact 8 comprises a protruding part 16 configured to fit in the recess 10 of the first charging contact 6. The protruding part 16 has two sides 18 which face the two side walls 12 of the recess 10 of the first charging contact 6 when in contact. Each side 18 of the protruding part 16 is provided with metal plates 20 having its sharp side facing the surface of the resilient metal plates 14 of the first charging contact 6, when in contact.

The front 22 of the protruding part 16 is U-shaped and the legs of the U constitute the sides 18 of the second charging contact 8. With the U-shape of front 22 an air gap is provided between the both the legs of the U. This air gap prevents conduction of current between the two metal plates 20 of the second charging contact 8 is prevented, which further prevents degradation and/or oxidation of the metal plates 20.

Each of the resilient metal plates 14 are fixed to a rear wall 24 of the recess 10 and to the side wall 12 in a front 26 of the recess 10, which best shown in schematic view of FIG. 4. The resilient metal plates 14 are essentially arc-shaped between the two fixation points along the side wall 12 and with the arc protruding into the recess 10. The essentially arc-shaped resilient metal plates 14 are formed such that the resilience thereof is resilient enough to enhance insertion of the second charging contact 8 into the recess 10 of the first charging contact 6, but resistant enough to ensure god contact between the resilient metal plates 14 of the first charging contact 6 and the metal plates 20 of the second charging contact 8 and to ensure that the pressure of the sharp sides of metal plates 20 against the resilient metal plates 14 is great enough to grind off any oxide that has accumulated on the charging contacts 6, 8. One advantage with providing the second charging contact 8 with the metal plates 20, such that they have their sharp sides in contact with the resilient metal plates 14 of the first charging contact 6 and not the other way around is that, as mentioned above, the second charging contact 6 on the charging station 2 is more exposed to the environment and thus it is more likely that oxide will be cluttered thereon.

In one exemplary embodiment each resilient metal plate 14 is fixed along and extending parallel to the rear wall 24 and has an angle of 100°-135° between the part fixed to the rear wall 24 and the arc-shaped part of the resilient metal plate 14 extending into the recess 10. This configuration ensures the above-mentioned balance between resilient enough and resistant enough.

As mentioned above the metal plates 20 of the second charging contact 8 are provided on the sides 18 of the protruding part 16. In an exemplary embodiment the metal plates 20 are inserted into the sides 18 of the protruding part 16. To enhance assembling of the second charging contact 8, the protruding part 16 is made of two parts, an upper part 30 and a lower part 32 in relation to the mowing surface, see FIG. 6. One of the upper part 30 or the lower part 32 is provided with a ridge or projection 34 which corresponds to an opening 28 in the metal plate 20 of the second charging contact 8. The other one of the upper part 30 or the lower part 32 is provided with a corresponding recess 36, in which the ridge or projection fits. When assembling the protruding part 16 of the second charging contact 8, the metal plate 20 of the second charging contact 8 is mounted on the ridge or projection 34 of one of the upper part 30 or lower part 32, the ridge or projection 34 matching with the corresponding opening 28 of the metal plate 20. Thereafter, the other one of the upper part 30 or the lower part 32 is put on top of upper part 30 or the lower part 32 on which the metal plate has been mounted. The upper part 30 and the lower part 32 can be fitted together by using a snap fit, an adhesive or any other suitable means to join the parts together. The ridge or projection 34 together with the opening 28 in the metal plate 20 together preferably form a press fit such that the metal plate 20 is firmly fixed to the side wall 18 of the protruding part 16 such that it easily can grind off oxide cluttered thereon, but also on the resilient metal plates 14 when making contact therewith.

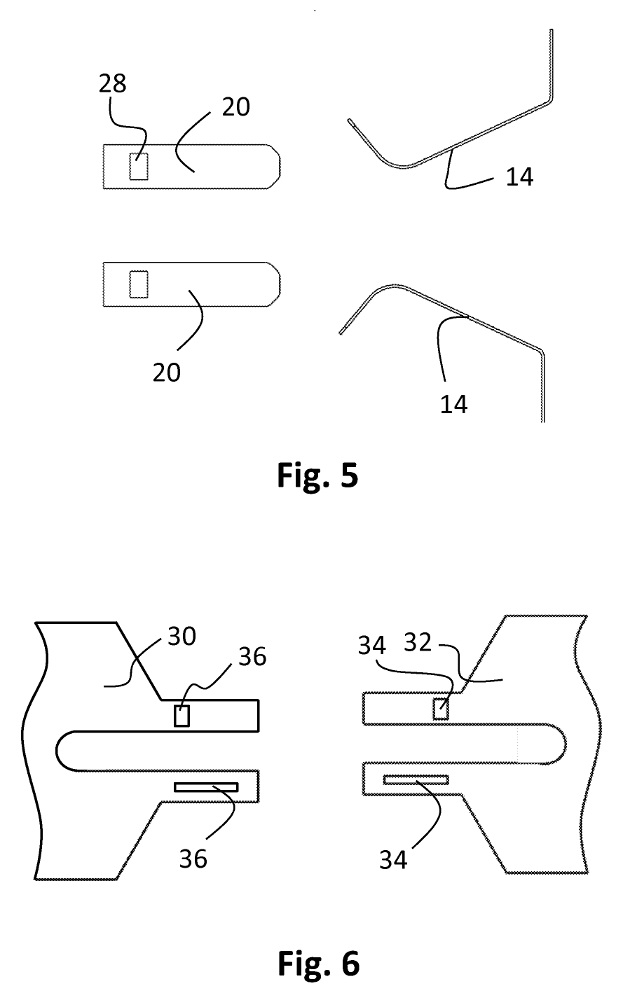

Turning now to FIG. 5, the metal plates of the first charging and second charging contact will be closer described. The height of the resilient metal plate 14, i.e. in the direction parallel with the side wall 12 of the recess 10, is between 3-15 mm, preferably between 4-12 mm and more preferably between 5-10 mm. The thickness, i.e. the sharp side, of the of the metal plates 20 of the second charging contact 8 is between 0.5-4 mm, preferably between 0.5-3 mm and more preferably between 0.7-1.5 mm.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean "one and only one" unless explicitly so stated, but rather "one or more." All structural and functional equivalents to the elements of the above-described embodiments that are known to those of ordinary skill in the art are expressly incorporated herein and are intended to be encompassed hereby.

1. A charging coupling (100) for connecting a robotic mower (2) to a charging station (4), wherein a first charging contact (6) of the charging coupling (100) is provided on the robotic mower (2) and a second charging contact (8) is provided on the charging station (4), the first charging contact (6) comprising a recess (10) having two side walls (12) substantially perpendicular to a mowing surface of the robotic mower (2) and each provided with a resilient metal plate (14), the second charging contact (8) comprising a protruding part (16) configured to fit in the recess (10) of the first charging contact (6) and having two sides (18) facing the two side walls (12) of the recess (10) of the first charging contact (6) when in contact, each side (18) of the protruding part (16) being provided with metal plates (20) with its sharp side facing the surface of the resilient metal plates (14) of the first charging contact (6), when in contact.

2. The charging coupling (100) according to claim 1, wherein the front (22) of the protruding part (16) is U-shaped and the legs of the U constitute the sides (18) of the second charging contact (8).

3. The charging coupling (100) according to claim 1, wherein each resilient metal plate (14) is fixed to a rear wall (24) of the recess (10) and to the side wall (12) in a front (26) of the recess (10) and is essentially arc-shaped there in between along the side wall (12) and with the arc protruding into the recess (10).

4. The charging coupling (100) according to claim 3, wherein each resilient metal plate (14) is fixed along and extending parallel to the rear wall (24) and has an angle of 100°-135° between the part fixed to the rear wall (24) and the arc-shaped part of the resilient metal plate (14) extending into the recess (10).

5. The charging coupling (100) according to claim 1, wherein the metal plates (20) of the second charging contact (8) are inserted into the side (18) of the protruding part (16).

6. The charging coupling (100) according to claim 1, wherein the second charging contact (8) is made of two parts, one upper part (30) and one lower part (32) in relation to the mowing surface, wherein either the upper part (30) or the lower part (32) is provided with a ridge (34) adapted to mate with an opening (28) provided in the metal plates (20) of the second charging contact (8).

7. The charging coupling (100) according to claim 1, wherein the height of the resilient metal plate (14) is between 3-15 mm, preferably between 4-12 mm and more preferably between 5-10 mm.

8. The charging coupling (100) according to claim 1, wherein the thickness of the metal plates (20) of the second charging contact (8) is between 0.5-4 mm, preferably between 0.5-3 mm and more preferably between 0.7-1.5 mm.

9. The charging coupling (100) according to claim 1, wherein the resilient metal plate (14) is essentially rectangular with its height extending essentially in parallel with the side wall (12) and its width extending along the side wall (12).
